(19) United States
(12) Patent Application Publication
(10) Pub. No.: US 2005/0241756 A1
(43) Pub. Date: Nov. 3, 2005

(54) Adhesive material and structures formed therewith

(75) Inventors: Matthew Harthcock, Oakland Township, MI (US); Christopher Hable, Romeo, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/114,631

(22) Filed: Apr. 26, 2005

Related U.S. Application Data
(60) Provisional application No. 60/565,964, filed on Apr. 28, 2004.

(51) Int. Cl. B32B 31/00

(52) U.S. Cl. 156/305; 156/295

(57) ABSTRACT

An adhesive material includes a polymeric component and one or more curing agents. The adhesive material is typically activated to cure upon exposure to a stimulus such as pressure.

### CLAIM OF PRIORITY

To the extent applicable, the present invention claims the benefit of the priority of U.S. Provisional Application Ser. No. 60/565,964, filed Apr. 28, 2004, the contents of which are incorporated by reference herein.

### FIELD OF THE INVENTION

The present invention relates to an adhesive material and more particularly, to an adhesive material, which is typically activated by a stimulus experienced during manufacture of a structure of an article of manufacture (e.g., a transportation vehicle such as an airplane or automotive vehicle).

### BACKGROUND OF THE INVENTION

Manufacture of various articles such as buildings, furniture, transportation vehicles or the like typically involve several processing steps. During such processing steps, adhesive materials that assist in forming the articles of manufacture are typically exposed to a variety of stimuli such as heat, pressure, humidity, combinations thereof or the like. Industry, in general, has attempted to create materials that do not interfere with these manufacturing processes. Furthermore, industry has attempted to create materials that use the stimuli of these processing steps to assist in desired formation of the articles of manufacture. In the interest of continuing such innovation, the present invention provides an adhesive material that can be activated by a stimulus experienced during manufacture and provides one or more structures that incorporate the material.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective cut away view of an exemplary adhesive material in accordance with an aspect of the present invention; and

FIG. 2 is a perspective cut away view of an exemplary structure formed in accordance with an aspect of the present invention.

### DETAILED DESCRIPTION OF THE INVENTION

The present invention is predicated upon the provision of an adhesive material. More particularly, the present invention is predicated upon the provision of an adhesive material that is naturally activated by processing steps that are used to form a structure of an article of manufacture. As such, the present invention is also related to one or more structures that are advantageously formed using the adhesive material. While the adhesive material typically adheres to one or more members for assisting in the formation of a structure of an article of manufacture, it is further contemplated that the adhesive material can assist in providing functional attributes such as structural reinforcement, baffling, sealing, acoustical damping properties, vibration damping properties or a combination thereof within a cavity or upon a surface of one or more structures (e.g., a wing) of an article of manufacture (e.g., an aircraft).

Generally, the adhesive material includes the following:
1) a polymeric component that includes one or more polymeric compounds; and
2) one or more curing or reactive agents for curing or reacting at least a portion of the polymeric component;

typically the adhesive material is activated by the application of a stimulus such as pressure and activation typically includes curing at least a portion of the polymeric component with the assistance of the one or more curing agents.

Polymeric Component

The adhesive material typically includes a polymeric component, which may comprise an admixture of multiple different polymeric materials (e.g., thermoplastics, elastomers, plastomers, plasticizer, plastic, combinations thereof or the like) or may substantially comprise only one or two different polymeric materials. Examples of suitable polymeric materials include halogenated polymers, polycarbonates, polyketones, urethanes, polyols, polyethers, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer), mixtures thereof or the like. Other potential polymeric materials, which may or may not be combined with the above materials include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate, combinations thereof or the like.

The polymeric component typically comprises at least about 10% or less, more typically at least about 30% and even more typically at least about 60% by weight of the adhesive material. The polymeric component also typically comprises less than about 90% or greater, more typically less than about 80% and even more typically less than about 70% by weight of the adhesive material.

According to one embodiment, the polymeric component is epoxy-based (i.e., includes at least about 30%, more typically at least about 45% and even more typically at least about 65% epoxy materials). The adhesive material may be formed from a variety of formulations having epoxy material and preferably epoxy resin integrated therein. Epoxy resin or material is used herein to mean any of the conventional dimeric, oligomeric or polymeric epoxy materials containing at least one epoxy functional group. The epoxy materials may be epoxy-containing materials having one or more oxirane rings polymerizable by a ring opening reaction.

The epoxy may be aliphatic, cycloaliphatic, aromatic or the like. The epoxy may be supplied as a solid (e.g., as pellets, chunks, pieces or the like) or a liquid. The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive.

In another embodiment, the adhesive material may be acrylate-based (i.e., includes at least about 30%, more typically at least about 45% and even more typically at least about 65% acrylate materials). The acrylates may include, for example, simple acrylate, methyl acrylate, ethyl acrylate, butyl acrylate, vinyl acrylate, copolymers or combinations thereof or the like. Moreover, any of these acrylates may include or be mixed with other chemical groups such as epoxy, ethylene, butylene, pentene or the like for forming compounds such as ethylene acrylate, ethylene methyl acrylate and so on, and additionally for forming copolymers or combinations thereof or the like.

One exemplary possible acrylate material is a copolymer of butyl acrylate and methyl acrylate and more particularly a copolymer of an ethylene butyl acrylate and ethylene methyl acrylate. An example of such a copolymer is sold under the tradename LOTRYL 35BA40 and is commercially available from ATOFINA Chemical, Inc., 2000 Market Street, Philadelphia, Pa. 19103. Another possible acrylate is an epoxy modified (e.g., epoxidized) acrylate copolymer. An example of such a copolymer is sold under the tradename ELVALOY 4170 and is commercially available from E. I. Dupont De Nemours and Company, 1007 Market Street, Wilmington, Del. 19898.

In yet another embodiment, the polymeric component may be based upon (i.e., include at least about 30%, more typically at least about 45% and even more typically at least about 65%) one or more isocyanate reactive compounds (e.g., polyols). Various isocyanate reactive compounds can be used to form an isocyanate reactive component, which, in turn, can be used to form the activatable material. Isocyanate-reactive compounds suitable for the activatable material generally include from about 1 to about 8 or more isocyanate-reactive groups and preferably from about 2 to about 6 isocyanate-reactive groups. Suitable compounds include polyacetals, polycarbonates, polyesterethers, polyester carbonates, hydrocarbons polythioethers, polyamides, polyols (e.g., di- or polyhydric alcohols) such as polyethers, glycols, polyesters and castor oil, polyesteramides, polysiloxanes, polybutadienes, and polyacetones. The isocyanate-reactive compounds typically contain from about 2 or fewer to about 4 or greater reactive amino or hydroxyl groups.

While the present invention specifically addresses epoxy, acrylate and polyurethane systems, it is contemplated that combinations of these systems may be employed. Moreover, other polymeric systems may be used in addition to or as an alternative to epoxy, acrylate and/or polyurethane systems.

Curing Agent

Various curing agents and/or curing agent accelerators may be employed in the adhesive material of the present invention. Amounts of curing agents and curing agent accelerators can vary widely within the adhesive material depending upon the desired cure rate, the desired properties or attributes of the adhesive material or the like. Thus, the adhesive material can include at least about 0.1% or less, more typically at least about 1% and even more typically at least about 3% by weight curing agent, curing agent accelerator or both. However, the adhesive material typically includes less than about 60% or greater, more typically less than about 35%, even more typically less than about 15%, even more typically less than about 11% and still more typically less than about 7% by weight curing agent, curing agent accelerator or both.

Typically, the curing agents assist the adhesive material and particularly the polymeric component thereof in curing by crosslinking or other reacting of the polymeric compounds of the polymeric component. It is also typical, although not required, for the curing agents to assist in thermosetting the adhesive material.

Amines, amides, peroxides or other chemicals are examples of typical curing agents or curing agent accelerators suitable for curing epoxies, acrylates, combinations thereof or the like. Useful classes of curing agents for such polymeric compounds include, without limitation, aliphatic or aromatic amines or their respective adducts, amidoamines, polyamides, cycloaliphatic amines, anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), peroxides or mixtures thereof. Other exemplary curing agents include modified and unmodified polyamines or polyamides such as triethylenetetramine, diethylenetriamine tetraethylenepentamine, cyanoguanidine, dicyandiamides and the like. Exemplary accelerators for the curing agents might include a modified or unmodified urea such as methylene diphenyl bis urea, an imidazole, a tertiary amine, a combination thereof or the like.

For isocyanate-reactive compounds, isocyanates are typically used for curing those compounds and for forming urethanes in the adhesive. It is contemplated that most any isocyanate having one or more isocyanate groups in the molecule may be used as a curing agent and may be used for curing the isocyanate-reactive compounds of the adhesive material. Both aliphatic or cycloaliphatic isocyanates, such as hexamethylene diisocyanate (HDI) or isophorone diisocyanate (IPDI) and/or aromatic isocyanates, such as toluene diisocyanate (TDI), diphenylmethane diisocyanate (MDI) or mixtures of diphenylmethane diisocyanate and polymethylenepolyphenylene polyisocyanates (crude MDI), mixture of TDI and MDI, combinations thereof or the like may be used. It is also possible to use isocyanates which were modified by the incorporation of urethane, uretidione, isocyanurate, allophanate, uretonimine and other groups, i.e. modified isocyanates.

Some particularly readily available polyisocyanates include, without limitation, 2,4- and 2,6-toluene diisocyanates and mixtures of these isomers (“TDI”); polyphenyl-polymethylene-polyisocyanates of the type obtained by condensing aniline with formaldehyde, followed by phosgenation (“crude MDI”); and polyisocyanates containing carbodiimide groups, urethane groups, allophanate groups, isocyanurate groups, urea groups, or biuret groups (“modified polyisocyanates”).

Fillers

The adhesive material of the present invention may include one or more fillers. When included, the adhesive material typically comprises at least about 2% or less, more typically at least about 7% and even more typically at least about 15% by weight filler. Also when included, the adhesive material typically comprises less than about 60% or greater, more typically less than about 40% and even more typically less than about 30% by weight filler.

The fillers of the adhesive material may also include, without limitation, particulated materials (e.g., powder), beads, microspheres, or the like. Preferably the filler includes a relatively low-density material that is generally non-reactive with the other components present in the adhesive material.

Examples of fillers include silica, diatomaceous earth, glass, clay, nanoparticles (e.g., nanoclay), talc, pigments, colorants, glass beads or bubbles, glass, carbon ceramic fibers, antioxidants, and the like. Such fillers, particularly clays, can assist the adhesive material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular can improve the impact resistance of the cured adhesive material.

It is contemplated that one of the fillers or other components of the material may be thixotropic for assisting in controlling flow of the material as well as properties such as tensile, compressive or shear strength.

Additives

Other additives, agents or performance modifiers may also be included in the adhesive material as desired, including but not limited to a UV resistant agent, a flame retardant, an impact modifier, a heat stabilizer, a UV photoinitiator, a colorant, a processing aid, an anti-oxidant, a lubricant, a coagent, a reinforcement materials (e.g., chopped or continuous glass, glass fiber, ceramics and ceramic fibers, aramid fibers, aramid pulp, carbon fiber, acrylate fiber, polyamide fiber, polypropylene fibers, combinations thereof or the like). In one preferred embodiment, for example, an acrylate coagent may be employed for enhancing cure density. It is also contemplated that the adhesive material may include about 0.10 to about 5.00 weight percent of an anti-oxidant such as a propionate (e.g., pentaerythritol tetrakis (3-(3,5-di-tert-butyl-4-hydroxyphenyl) propionate)) for assisting in controlling oxidation, cure rate or both. An example of such an anti-oxidant is sold under the tradename IRGANOX® 1010 and is commercially available from Ciba Specialty Chemicals Company, 141 Klybeckstrasse, Postfach, 4002 Basel, Switzerland.

Activation

The adhesive material is typically activated to cure upon the exposure to a stimulus. Although it is contemplated that various additional or alternative stimuli such as heat, moisture or the like may be employed, the adhesive material is preferably activated to at least partially cure upon exposure to elevated pressure. In a preferred embodiment, the polymeric component or at least a portion thereof is maintained separate from the curing agent until the adhesive material is exposed to a pressure sufficient to expose the polymeric component to the curing agent.

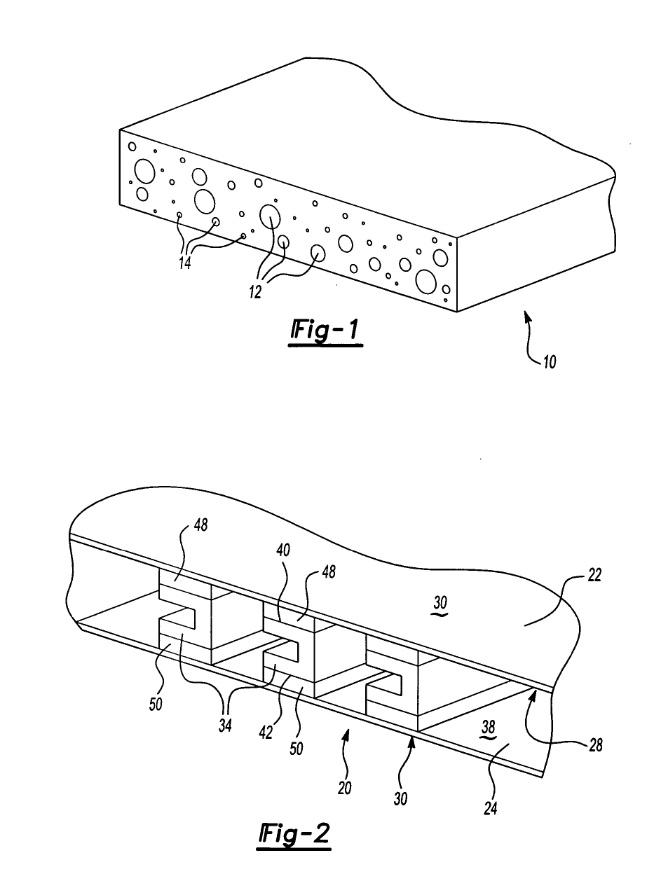

Typically, although not necessarily required, the polymeric component is maintained separate from the curing agent by encapsulating at least a portion of the polymeric compounds of the polymeric component, the curing agent or both of the adhesive material. Then, upon application of sufficient pressure, the encapsulation will typically fail (e.g., rupture, melt, flow or the like) thereby exposing the polymeric compounds to the curing agent with which they are reactive. With reference to FIG. 1, an adhesive material 10 according to the present invention is schematically shown. As can be seen, the adhesive material 10 includes both encapsulated polymeric compound 12 and encapsulated curing agent 14. It is additionally contemplated that, when used, any curing agent accelerator may also be encapsulated.

Various types of encapsulating techniques may be employed for forming the desired encapsulated material. For example, and without limitation, techniques such as submerged nozzle extrusion, spinning disc coating, interfacial polymerization, coacervation, spray drying, fluidized bed coating, combinations thereof or the like. The particular technique used and the type of encapsulation formed can depend upon the material to be encapsulated and the state (e.g., liquid, solid, gas or combination thereof) of that material. Exemplary materials that form the encapsulation can include polymeric materials (e.g., thermoplastics, elastomers, plastics, waxes, thermosets, combinations thereof or the like).

Various sizes, shapes and thickness, various different materials, combinations thereof or the like for the encapsulation can provide or allow for rupture of the encapsulation at different pressure levels. Thus, rupture of the encapsulation and, therefore, activation of the adhesive material can occur at a variety of different pressures. Typically, the pressure of activation is at least greater than atmospheric pressure (e.g., at least about 150 kPA, more typically at least about 1 MPa and even more typically at least about 10 MPa).

Typically, for encapsulated materials, it is preferable that the one or more curing agents can cure the polymeric compounds at a temperature below about 100° C., more typically below about 70° C. and even more typically below about 40° C. (e.g., about room temperature around 23° C.).

In addition to curing, the adhesive material may, optionally, also be activated to expand or foam and, therefore, may include a blowing agent or, alternatively, the reaction of the polymeric component with the curing agent may liberate a gas for foaming or expanding the adhesive material. If used, the foaming or expansion of the adhesive material may be able to assist the adhesive material in wetting and/or adhering to members of a structure.

Generally, for polyurethane systems (e.g, systems with isocyanates and isocyanate-reactive compounds) various different combinations of components can provide for a system that only cures or for a system that expands or foams and cures.

For other systems (e.g., epoxy/amine, acrylate/amine, acrylate/peroxide or other systems), and even for polyurethane systems, an additional blowing agent (e.g., a physical or chemical blowing agent) may be needed or desired for foaming or expanding. Exemplary blowing agents can include one or more nitrogen containing groups such as amides, amines and the like or can be thermoplastic encapsulated solvents or other chemicals. Typically, for a pressure activated system, it is desirable for the blowing agents to create a blowing effect at a temperature below about 100° C., more typically below about 70° C. and even more typically below about 40° C. (e.g., about room temperature around 23° C.). Thus, when included, the blowing agent may be encapsulated in a manner as described for the polymeric compounds, the curing agents or both.

An accelerator for the blowing agents may also be provided in the adhesive material and may be encapsulated as well. Various accelerators may be used to increase the rate at which the blowing agents form inert gasses. One exemplary blowing agent accelerator is a metal salt, or is an oxide, e.g. a metal oxide, such as zinc oxide. Other exemplary accelerators include modified and unmodified thiazoles or imidazoles.

The blowing agent, the blowing agent accelerator, or both, when included, are generally included in the adhesive material in an amount of from about 0.05 to about 7% by weight, based on total weight of adhesive material, preferably from about 0.1 to about 6% by weight, most preferably from about 0.5 to about 5% by weight.

Formation

Formation of the adhesive material can be accomplished according to a variety of new or known techniques. Preferably, the adhesive material is formed as a material of substantially homogeneous composition. However, it is contemplated that various combining techniques may be used to increase or decrease the concentration of certain components in certain locations of the adhesive material.

According to one embodiment, the adhesive material is formed by supplying the components of the material in solid form such as pellets, chunks, encapsulations and the like, in liquid form or a combination thereof. The components are typically combined in one or more containers such as large bins or other containers. Preferably, the containers can be used to intermix the components by rotating or otherwise moving the container or the material therein. Thereafter, heat, pressure or a combination thereof may be applied to soften or liquidize the components such that the components can be intermixed by stirring or otherwise into a single homogenous composition. When used, such heat and/or pressure are typically relatively low so as not to damage or rupture any encapsulations. Thus, it may be desirable for the polymeric compounds and/or other components of the adhesive material to have relatively low viscosities for allowing mixing under lower pressure and lower heat conditions.

According to another embodiment, the activatable material may be formed by heating one or more of the components that is generally easier to soften or liquidize such as the polymer based materials to induce those components into a mixable state. Thereafter, the remaining components may then be intermixed with the softened components.

Application

The adhesive material may be employed in a variety of structures of a variety of articles of manufacture. Generally, the adhesive material is located between at least one surface of a first member and at least one surface of a second member. Once between the members, and preferably contacting the surfaces of the members, the adhesive material is typically exposed to a stimulus, which is typically a pressure, that activates the adhesive material. Such pressure may be applied by moving the surface of the first member toward the surface of the second member or may be otherwise applied.

Referring to FIG. 2, there is illustrated a structure of an aircraft, or more particularly, a wing 20 of an airplane. The wing 20 includes a pair of first members shown as a first or upper panel 22 (e.g., skin) and a second or lower panel 24 (e.g., skin). As can be seen, each of the panels 22, 24 includes an inner or first surface 28 and an outer or second surface 30.

A plurality of second members, shown as ribs 34, are located between the panels 22, 24. As shown, each of the ribs 34 are generally channel shaped, although the ribs 34 could be otherwise shaped as desired. Each of the ribs 34 also typically includes one or more attachment surfaces. In the embodiment shown, each of the ribs 34 includes a first or upper attachment surface 40 opposing the inner surface 28 of the first panel 22 and a second or lower attachment surface 42 opposing the inner surface 28 of the second panel 24.

Masses of adhesive material of the present invention can be located between the ribs 34 and the first panel 22, the second panel 24 or both of the wing 20 for adhering the ribs 34 to the panels 22, 24. In the particular embodiment shown, strips 48, 50 of the adhesive material have been located respectively between the attachment surfaces 40, 42 of each rib 34 and the inner surfaces 28, of the first and second panels 22, 24. For locating the adhesive material, techniques such as extrusion, molding-in-place or other techniques may be used to apply (e.g., adhere) the adhesive material to the surfaces of the ribs, the panels or combinations thereof.

During assembly of the wing (e.g., assembly or attachment of the panels and ribs together), the strips 48, 50 of adhesive material are typically compressed between surfaces 40, 42 of the ribs 34 and the surfaces of the panels 22, 24 such that the strips 48, 50 are exposed to a pressure sufficient to activate the adhesive material. The pressure may be exerted during the fastening or attachment of the components such as the panels and the ribs together or to each other, although other processing steps may also apply pressure. Such attachment or fastening may include, without limitation, mechanical fastening (e.g., with rivets, screw or other mechanical fastening), adhesive fastening, combinations thereof or the like.

Typically, the adhesive material, during processing, is exposed to a pressure greater than about 100 psi, more typically greater than 900 psi and even more typically greater than about 2500 psi (e.g., about 3000 psi) such that the encapsulations of the polymeric compounds, the curing agent, curing agent accelerator, or a combination thereof and, if used, the encapsulations of the blowing agent, the blowing agent accelerator or both fail (e.g., rupture) such that the adhesive material can cure, expand or foam and adhere to the surfaces 40, 42, 28 of the ribs 34 and panels 22, 24.

Although cure times for substantial curing (e.g., at least about 80% of cure properties) of the adhesive material can vary widely, cure times are typically at least about 5 hours or less, more typically at least about 10 hours and even more typically at least about 15 hours. Cures times are also typically less than about 1000 hours or greater, more typically less than 100 hours and even more typically less than about 30 hours.

While the adhesive material has been shown as applied to a wing of an aircraft, it is generally contemplated that the adhesive material may be applied to a variety of structures of a variety of transportation vehicles or other articles of manufacture particularly in situations where the adhesive material is subject to elevated pressures caused by the assembly process thereof. For example, the adhesive material may be located between any two of the following components: body panels of automotive vehicles, aircraft or other structures, frame or structural members of automotive vehicles, aircraft or other structures or other members of articles, combinations thereof or the like.

In other particular alternative embodiment, it is contemplated that the adhesive material of the present invention may be employed in conjunction with one or more mechanical fasteners (e.g., threaded fasteners such as nut and bolt assemblies, clamps, combinations thereof or the like). In such an embodiment, the adhesive material is place between two members of an article of manufacture, between two components (e.g., a nut and bolt) of the fastener, between a component of the fastener and a member of an article of manufacture or a combination thereof. Then, upon application of pressure applied by the fastener (e.g., upon tightening or clamping of the fastener), the adhesive material can be activated as described above and can adhere to the member of the article and/or to the fastener.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A method of forming a structure of an article of manufacture, the method comprising:
providing a first member and a second member of the structure;
locating an adhesive material between the first member and the second member wherein at least a portion of the adhesive material is located within encapsulations;
activating the adhesive material to cure between the first member and the second member by exposing the adhesive material to a stimulus that causes the encapsulations to fail.

2. A method as in claim 1 wherein the encapsulations fail by rupturing, flowing or melting.

3. A method as in claim 1 wherein the adhesive material includes a polymeric component and at least one curing agent and activating the adhesive material includes exposing the polymeric component to the at least one curing agent thereby causing the adhesive material to cure and adhere to the first member and the second member.

4. A method as in claim 3 wherein the polymeric component includes one or more polymeric compounds, which include an epoxy resin.

5. A method as in claim 4 wherein the at least one curing agent includes an amine, an amide, an isocyanate or a peroxide.

6. A method as in claim 5 wherein the at least one curing agent is at least about 1%, but less than about 60% by weight of the adhesive material.

7. A method as in claim 6 wherein the polymeric component is epoxy-based and the polymeric component is at least about 30%, but less than about 80% by weight of the adhesive material.

8. A method as in claim 7 wherein the first and second member are part of an airplane.

9. A method as in claim 8 wherein the first and second member are part of a wing of the airplane.

10. A method as in claim 1 wherein the first and second member are part of an airplane.

11. A method as in claim 10 wherein the first and second member are part of a wing of the airplane.

12. A method as in claim 11 wherein the first member is a rib and the second member is a panel.

13. A method of forming a structure of an article of manufacture, the method comprising:
providing a first member and a second member of the structure;
locating an adhesive material between the first member and the second member, wherein:
i. the adhesive material includes at least one curing agent and a polymeric component; and
ii. multiple encapsulations encapsulate at least a portion of the polymeric material, the curing agent or both;
activating the adhesive material by applying pressure to the adhesive material such that the multiple encapsulations rupture thereby causing the adhesive material to cure between and adhere to the first member and the second member and form the structure.

14. A method as in claim 13 wherein the encapsulations are formed of a thermoplastic.

15. A method as in claim 13 wherein the pressure is at least 1 MPa.

16. A method as in claim 13 wherein the at least one curing agent can cure the polymeric component at a temperature below about 100° C.

17. A method as in claim 8 wherein:
i. the first and second member are part of a wing of an airplane;
ii. the polymeric component is epoxy-based;
iii. the at least one curing agent includes an amine, an amide or a peroxide
iv. the at least one curing agent is at least about 1%, but less than about 35% by weight of the adhesive material; and
v. the polymeric component is at least about 30%, but less than about 80% by weight of the adhesive material.

18. A method of forming a structure of a wing of an aircraft, the method comprising:
providing a first member and a second member of the structure of the wing of the aircraft, wherein:
i. the first member is a panel of the wing; and
ii. the second member is a rib of the wing;
locating an adhesive material between the first member and the second member, wherein:
i. the adhesive material includes at least one curing agent and a polymeric component; and
ii. multiple encapsulations encapsulate at least a portion of the polymeric material, the curing agent or both;
activating the adhesive material by compressing the adhesive material between the first member and the second member such that the multiple encapsulations rupture thereby causing the adhesive material to cure between and adhere to the first member and the second member and form the structure.

19. A method as in claim 8 wherein:
i. the first and second member are part of a wing of the airplane;
ii. the polymeric component is epoxy-based;
iii. the at least one curing agent includes an amine, an amide or a peroxide iv. the at least one curing agent is at least about 1%, but less than about 11% by weight of the adhesive material; and
v. the polymeric component is at least about 30%, but less than about 80% by weight of the adhesive material.

20. A method as in claim 13 wherein:
i. the encapsulations are formed of a thermoplastic;
ii. the pressure is at least 1 MPa; and
iii. the at least one curing agent can cure the polymeric component at a temperature below about 100° C.
